(19) United States
(12) Patent Application Publication
(10) Pub. No.: US 2022/0163488 A1
(43) Pub. Date: May 26, 2022

(54) FULL TRAIN WHEEL CONTROL

(71) Applicant: Olympus NDT Canada Inc., Québec (CA)

(72) Inventors: Dominique Nogues, Québec (CA); Christian Lachance, Lévis (CA)

(21) Appl. No.: 17/103,211

(22) Filed: Nov. 24, 2020

(51) Int. Cl. G01N 29/28; G01N 29/22; G01N 29/04

(52) U.S. Cl. CPC G01N 29/28; G01N 29/225; G01N 2291/2696; G01N 2291/0289; G01N 2291/106; G01N 29/043

(57) ABSTRACT

An inspection system for inspecting an article, such as a railway wheel, is provided. The inspection system includes a robotic arm and a bath having a couplant. The inspection system has three sensors in the bath and in fluid communication with the couplant. The first sensor couples with the bath and is positioned within the bath to inspect a first area of an article. The second sensor couples with the bath different from the first sensor and is positioned to inspect a second area of the article. The third sensor is coupled with the bath and is positioned within the bath to inspect a third area of the article. One of the sensors couples with the bath such that during an inspection of the article within the bath the sensor may be adjusted to inspect a fourth area of the article.

### TECHNICAL FIELD

This document pertains generally, but not by way of limitation, to an article inspection system. More specifically, but not by way of limitation, the present application relates to a bath for an article inspection system.

### BACKGROUND

During use, railway wheels can be exposed to a great amount of dynamic stress. For this reason, railway wheels are generally tested in order to detect material flaws that can occur during manufacturing of the railway wheel. Railway wheels may be tested to demonstrate compliance with a plurality of standards before they can be used with railcars. These standards can include the EN13262, ISO5948, and AAR M107/208 standards. These standards specify the characteristics for railway wheels that are set based on the application of the railcar that will use the railway wheel. Typically, testing according to EN 13262 involves tensile strength evaluations, impact tests, toughness tests, and hardness tests using non-destructive procedures.

Accordingly, what is needed is a testing system that quickly inspects an article, such as a railway wheel. Moreover, the system should minimize the number of elements necessary to complete an inspection.

### SUMMARY

Examples of the present disclosure relate to a bath for inspecting an article. In an implementation, the bath can include a plurality of sensors disposed within the bath. In an implementation, a first sensor of the plurality of sensors is positioned within the bath such that the first sensor can be configured to inspect a first area of an article using fluid communication through a couplant. In an implementation, a second sensor of the plurality of sensors is positioned differently from the first sensor within the bath such that the second sensor can be configured to inspect a second area of the article using fluid communication through the couplant. Moreover, a third sensor of the plurality of sensors is positioned within the bath such that the third sensor can be configured to inspect a third area of the article using fluid communication through the couplant. In an implementation, at least one sensor of the plurality of sensors is coupled to the bath such that during an inspection, the at least one sensor moves during inspection of the article.

Examples of the present disclosure relate to an inspection system that comprises a robotic arm, a bath having a couplant, and a plurality of sensors disposed in the bath. In an implementation, the robotic arm places an article into the bath for inspection by the plurality of sensors. In an implementation, a first sensor of the plurality of sensors is positioned within the bath such that the first sensor can be configured to inspect a first area of an article using fluid communication through a couplant. In an implementation, a second sensor of the plurality of sensors is positioned differently from the first sensor within the bath such that the second sensor is configured to inspect a second area of the article using fluid communication through the couplant. In an implementation, a third sensor of the plurality of sensors is positioned within the bath such that the third sensor is configured to inspects a third area of the article using fluid communication through a couplant. In an implementation, at least one sensor of the plurality of sensors is coupled to the bath such that during an inspection, the at least one sensor can be configured to move during inspection of the article. In an implementation, the single robotic arm is configured to retrieve the article from the bath when an additional inspection is not necessary.

Further examples of the present disclosure relate to a method of using an inspection system that comprises a robotic arm, a bath having a couplant, and a plurality of sensors disposed in the bath. In an implementation, a first sensor of the plurality of sensors can inspect a first area of an article and a second sensor of the plurality of sensors can be configured to inspect a second area. A third sensor of the plurality of sensors can be configured to inspect a third area of the article. In an implementation, the robotic arm is configured to obtain the article and position the article among the plurality of sensors for inspection. In an implementation, each of the first, second, or third sensors performs an inspection on one of the first, second, and third areas of the article. A determination is then made if an additional inspection is necessary. If an additional inspection is needed, in an implementation, the single robotic arm is enabled to reposition the article within the bath and an additional inspection is performed. Otherwise, the single robotic arm is configured to remove the article from the bath.

### BRIEF DESCRIPTION OF FIGURES

FIG. 1 illustrates a perspective view of a standard inspection system.

FIG. 2 illustrates an article and the web of an article.

FIG. 3 illustrates an inspection system for an article, in accordance with examples of the present disclosure.

FIG. 4 illustrates another view of the inspection of FIG. 3 in accordance with examples of the present disclosure.

FIG. 5 shows a perspective view of a sensor with pulsing elements, in accordance with examples of the present disclosure.

FIGS. 6A and 6B illustrate an article and the web of an article, in accordance with examples of the present disclosure.

FIGS. 7A-7C illustrate the inspection of an article in accordance with examples of the present disclosure.

FIG. 8 illustrates the inspection of an article in a first position within a bath having a plurality of sensors, in accordance with examples of the present disclosure.

FIG. 9 illustrates the inspection of the article shown with respect to FIG. 8 when the article is repositioned from the position shown with reference to FIG. 8, in accordance with examples of the present disclosure.

FIG. 10 illustrates the inspection of the article shown with respect to FIG. 9 when the sensors and the article are repositioned from the position shown with reference to FIG. 9, in accordance with examples of the present disclosure.

FIG. 11 illustrates the inspection of the article shown with respect to FIG. 10 when the sensors are repositioned from the position shown with reference to FIG. 10, in accordance with examples of the present disclosure.

FIG. 12 illustrates the inspection of the article shown with respect to FIG. 11 when the sensors and the article are repositioned from the position shown with reference to FIG. 11, in accordance with examples of the present disclosure.

FIG. 13 illustrates a perspective view of an inspection system for an article having a bath with a horizontal configuration in accordance with examples of the present disclosure.

FIG. 14 illustrates the bath shown with reference to FIG. 13, in accordance with examples of the present disclosure.

FIG. 15 illustrates a method of inspecting an article in accordance with examples of the present disclosure.

### DETAILED DESCRIPTION

Examples of the present disclosure relate to a bath for inspecting an article. In an implementation, the bath can include a plurality of sensors disposed within the bath. In an implementation, a first sensor of the plurality of sensors is positioned within the bath such that the first sensor can inspect a first area of an article using fluid communication through a couplant. In an implementation, a second sensor of the plurality of sensors is positioned different from the first sensor, such as being opposite the first sensor, within the bath such that the second sensor inspects a second area of the article using fluid communication through the couplant. Moreover, a third sensor of the plurality of sensors is positioned within the bath such that the third sensor inspects a third area of the article using fluid communication through the couplant. In an implementation, at least one sensor of the plurality of sensors is coupled to the bath such that during an inspection, the at least one sensor moves during inspection of the article. In an embodiment, moving can including the at least one sensor pivoting.

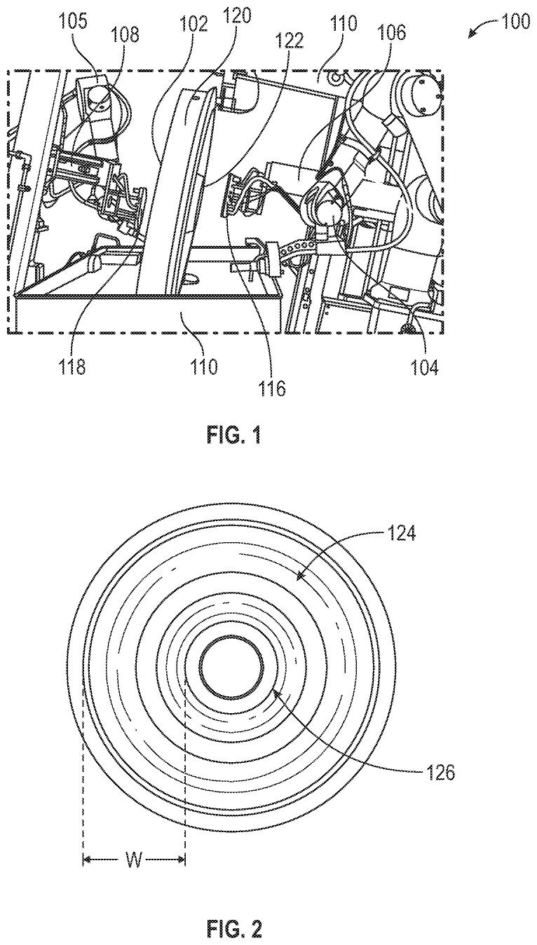

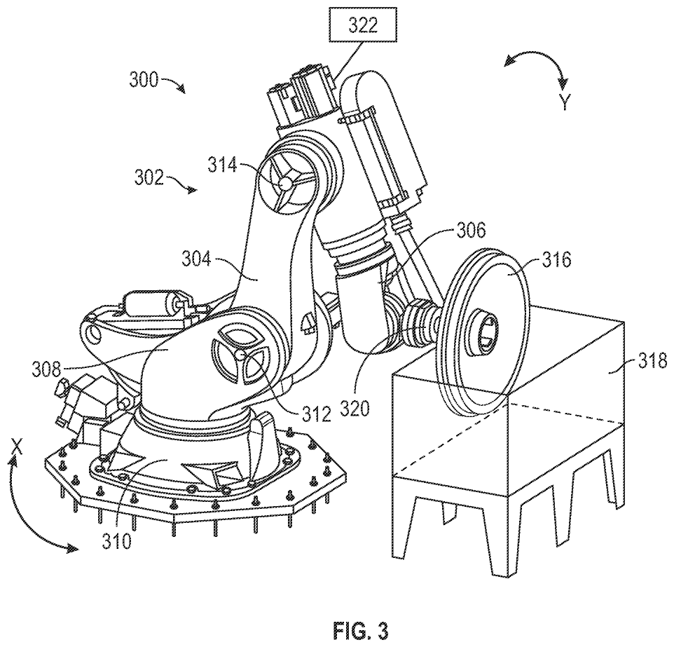

An example of non-destructive testing that can be done is shown with reference to FIG. 1, which illustrates an inspection system 100 for testing an article 102, such as a railway wheel. The inspection system 100 includes mechanical arms 104, 105, 106, and 108 and a bath 110 along with an arm 112. The mechanical arm 106 includes a sensor 116. In addition, the mechanical arm 108 includes a sensor 118. It should be noted that in some embodiments, mechanical arms are used for hub inspections. In further embodiments, the mechanical arms 104-108 can be robots for use in web inspection. The inspection system 100 uses ultrasonic testing to test a rim 120 along with a hub 122 and a web 124 (FIG. 2) of the article 102. Prior to testing, an apparatus separate from the inspection system 100, such as a crane, places the article 102 into the inspection system 100. During testing, a sensor (not shown) is used to test the rim 120 in accordance with the EN13262 standard. Afterwards, the mechanical arms 106 and 108 move the sensors 116 and 118 into place against the hub 122 to test the hub 122 in accordance with the EN13262 standard. Thereafter, the mechanical arm 106 moves the sensor 116 away from the hub 122 and the mechanical arm 108 moves the sensor 118 against the web 124. After the mechanical arm 108 moves the sensor 118 against the web 124, the inspection system performs ultrasonic testing of the web 124 using a couplant, such as water or a gel. During this phase of testing, the mechanical arms 106 and 108 move the sensors 116 and 118 along a path 126 as shown in FIG. 2. The mechanical arms 106 and 108 repeat the path 126 along a width W of the web 124. Oftentimes, a width of the path may be about 6 mm.

In the approach of FIG. 1, ultrasonic testing of the web 124 by the mechanical arms 106 and 108 and the sensors 116 and 118 takes a great amount of time since the mechanical arms 106 and 108 repeat the path 126 along the width W of the web 124. Additionally, the inspection system 100 includes numerous complex elements, such as the mechanical arms 104 and 106 along with the mechanical arms 108 and the arm 110. The numerous amounts of complex parts increase the possibility of failure occurring for the inspection system 100.

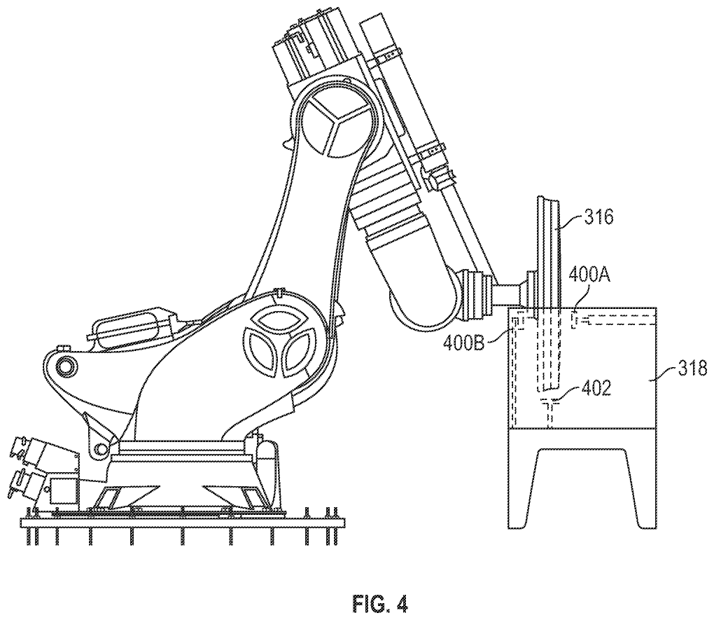

FIG. 3 shows a perspective view of a system 300 that can include a robot 302 having a robotic arm 304 rotatably coupled with a robotic arm 306. In an example of the present disclosure, the robot 302 can be a multiple axis robot. To further illustrate, the robot 302 can be a six-axis robot. However, the robot 302 is not limited to a six-axes and can be a robot having more or less axes. The robot 302 can also include a rotatable base 308 rotatably coupled with a fixed base 310. In this implementation, the rotatable base 308 may rotate about the fixed base 310 as shown with directional arrow X. The robotic arm 304 can be rotatably coupled with the rotatable base 308 about a pivot 312. Moreover, the robotic arm 306 can be rotatably coupled with the robotic arm 304 about a pivot 314. The pivots 312 and 314 allow rotation of the robotic arms 304 and 306 in a direction as shown with directional Y. The pivot 312 can be any mechanism that allows for rotational movement between the robotic arm 304 and the rotatable base 308, such as a pin, a pivot joint, a ball and socket, or the like. Similar to the pivot 312, the pivot 314 can be any mechanism that allows rotational movement between the robotic arm 304 and the robotic arm 306, such as a pin, a pivot joint, a ball and socket, or the like.

In an implementation, the robot 302 can be used to place an article 316 in a bath 318. Examples of the article 316 can include a railway wheel, or any other article formed of a metal or an alloy. In an implementation, the bath 318 may include a couplant, such as water or a gel, that facilitates ultrasonic inspections of the article 316. In an implementation, the robot 302 can pick up the article 316 from a transport mechanism (not shown), such as conveyor belt, at an axle 320 and place the article 316 into the bath 318. More specifically, the robotic arms 304 and 306 can rotate about the fixed base 310 into a position to pick up the article 316 via the axle 320. For example, the robotic arms 304 and 306 may rotate in the range of 180° from the position shown with reference to FIG. 3 and pick up the article 316. The robotic arms 304 and 306 may then rotate in the range of 180° and place the article 316 into the bath 318. Moreover, in an embodiment where the robot 302 is a six axis robot, the robotic arms 304 and 306 may rotate in the range of ±350°.

In an implementation, a controller 322 controls all of the components of the system 300, including the robotic arms 304 and 306 and the axle 320. In an implementation, the controller 322 can be implemented by means of a personal computer (PC), a tablet PC, a hybrid tablet, a mobile telephone, a web appliance, a network router, switch or bridge, or any machine capable of executing instructions (sequential or otherwise) that specify operations to be taken by that machine. Moreover, in an embodiment, the controller 322 can include a drive that drives various components, as detailed further below. An example of the controller 322 may include the KUKA KR C4 robot controller available from Kuka AG headquartered in Augsburg, Germany.

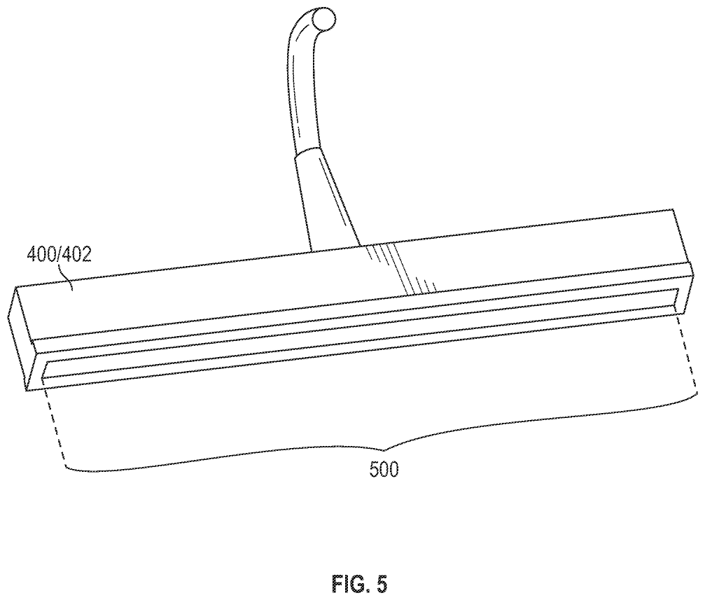

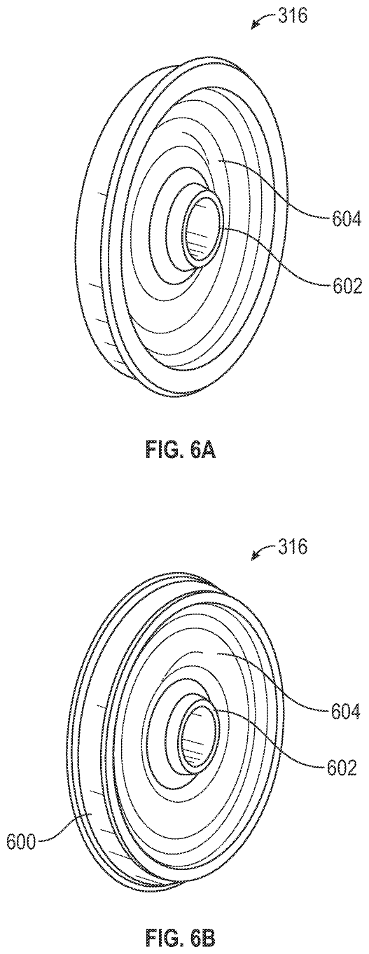

In an implementation, the bath 318 can include sensors 400A, 400B, and 402 through fluid communication I to inspect the article 316 when the article 316 is within the bath 318, as shown with reference to FIG. 4. While the bath 318 is shown as having three sensors, the sensors 400A and 400B and the sensor 402, it should be noted that the bath 318 can include any number of sensors having any configuration within the bath 318. In an implementation, each of the sensors 400A, 400B, and 402 can be a phased array acoustic transducers to emit a beam in a configurable direction for inspection, respectively. In an implementation, each of the sensors 400A, 400B, and 402 may be a phased array probe that includes any number of pulsing elements 500 (FIG. 5), such as 64 or 128 pulsing elements 500 that is capable of being used with refracted shear-wave ultrasonic inspections in an immersion tank, such as the bath 318. It should be noted that while 64 and 128 pulsing elements are described, the sensors 400A, 400B, and 402 may include any number of pulsing elements. Regardless of the number of elements, the beam emitted from the sensors 400A, 400B, and 402 using multiple elements can be controlled by individually pulsing each of the elements using a specific timing. An example of sensors that can be used for the sensors 400A, 400B, and 402 include immersion probes available from Olympus Corporation of the Americas headquartered in Center Valley, Pa.

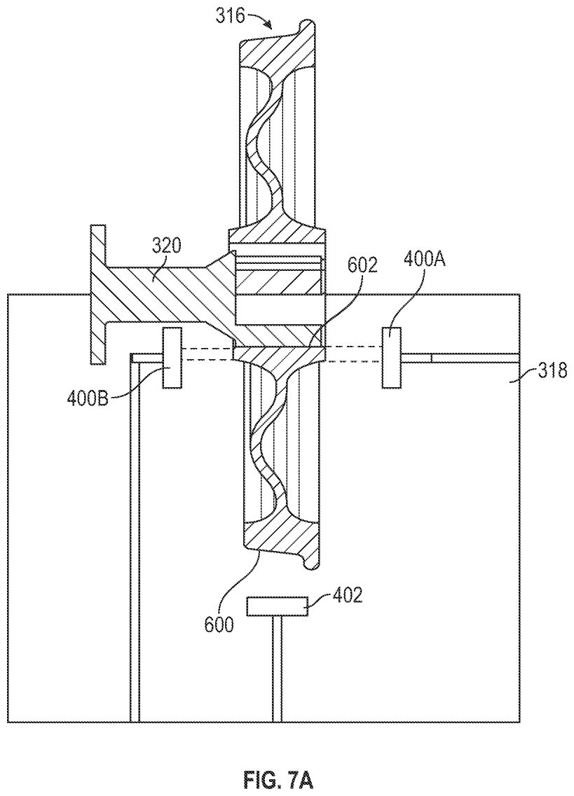

In embodiments, the sensors 400A, 400B, and 402 can be configured to inspect various areas of the article 316, such as a rim of the article 316 if the article 316 is a wheel. To further illustrate the concept of inspecting a rim of the article 316, reference is now made to FIGS. 6A and 6B, where the sensor 402 inspecting a rim 600 of the article 316 is shown in accordance with an embodiment of the present disclosure. Moreover, the sensors 400A and 400B inspect a hub 602 of the article 316 in implementations where the article 316 is a railway wheel. Furthermore, as will be discussed below, the sensors 400A and 400B are be configured to inspect a web 604 of the article 316 in implementations where the article 316 is a railway wheel for volumetric defects, such as voids or the like.

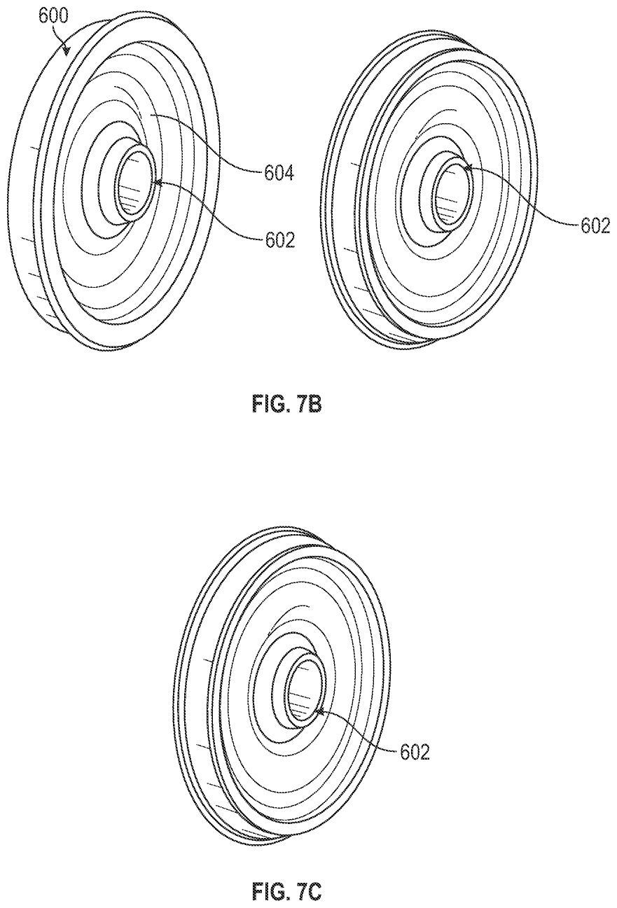

As mentioned above, the robotic arms 304 and 306 can operate to place the article 316 into the bath 318. During inspection, the controller 322 can be used to control the robotic arms 306 and 308 to place the article 316 into various positions in the bath 318 in order to facilitate inspection of different areas of the article 316. For example, in an implementation, the robotic arms 304 and 306 place the article 316 in a first position, as shown with reference to FIGS. 7A-7C. In the first position, the robotic arms 304 and 306 orient the article 316 in the bath 318 such that the sensor 402 inspects the rim 600 of the article 316. Additionally, in the first position, the controller 322 can be used to control the sensors 400A and 400B to inspect the hub 602 during a first inspection where the article 316 is rotated, as shown with reference to FIG. 7A-7C. After the robotic arms 304 and 306 place the article 316 in the bath 318 and the sensors 400A, 400B, and 402 commence inspection of the article 316, the controller 322 can be used to control the axle 320 to rotate the article 316 such that the sensor 402 can be configured to inspect the rim 600 of the article 316. Moreover, as the axle 320 rotates the article 316, the sensors 400A and 400B simultaneously are configured to inspect the hub 602. However, it should be noted that the sensors 400A and 400B may be configured to inspect the article 316 at separate times as the axle 320 rotates the article 316. As noted above, in an implementation, the sensors 400A, 400B, and 402 can be configured to inspect the article 316 ultrasonically. In particular, the pulsing elements 500 within the sensors 400A and 400B use ultrasonic techniques where elements within the sensors 400A and 400B emit beams onto the hub 602. Using this method of nondestructive testing, the sensors 400A and 400B may be configured to detect discontinuities, such as cracks or other types of flaws that are indicative of the quality of the hub 602 of the article 316. Similarly, the pulsing elements 500 within the sensor 402 use ultrasonic techniques where elements within the sensor 402 emit beams onto the rim 600 in order to detect cracks or other types of flaws that are indicative of the quality of the rim 600 of the article 316.

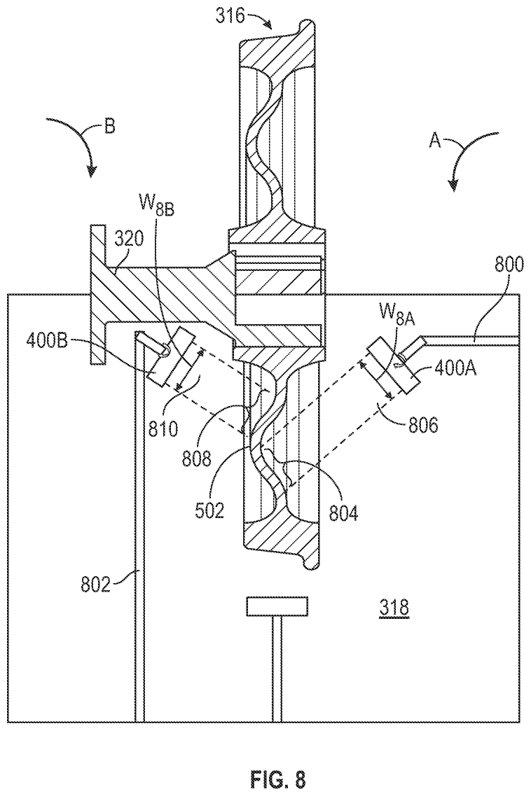

In an implementation, after the sensors 400A, 400B, and 402 respectively inspect the hub 602 and the rim 600 during the first inspection phase, the sensors 400A and 400B may be configured to position as shown in FIG. 8 to inspect the web 604 of the article 316 during a second inspection phase. In particular, the controller 322 controls the sensor 400A such that the sensor 400A can be moved downwardly, such as being moved downwardly about an arm 800 along a direction A, in order to allow the sensor 400A to inspect an area 804 of the web 604. Here, the pulsing elements 500 of the sensor 400A can be controlled by the controller 322 to emit a beam 806 to inspect the area 804. In an embodiment, a width W_{8A} of the beam 806 can be determined based on a size of the area 804. In an implementation, the width W_{8A} may be in a range of about 20 mm to about 190 mm. As the sensor 400A inspects the area 804 of the web 604, the axle 320 can be controlled to rotate the article 316 in the bath 318 such that the sensor 400A can be configured to inspect the entire web 604 at the area 804.

Moreover, the controller 322 is enabled to control the sensor 400B such that sensor 400B can be moved downwardly, such as being moved downwardly about an arm 802, along a direction B in order to allow the sensor 400B to inspect an area 808 of the web 604. Specifically, the pulsing elements 500 of the sensor 400B can be controlled to emit a beam 810 having a width W_{8B} to inspect the area 808. In an embodiment, a width W_{8B} of the beam 806 can be determined based on a size of the area 808 in a manner similar to the width W_{8A} of the beam 806. While the sensor 400B inspects the area 808 of the web 604, the axle 320 can be configured to rotate the article 316 in the bath 318 such that the sensor 400B can inspect the entire web 604 at the area 808. Since the axle 320 rotates the article 316 as the sensors 400A and 400B inspect the article 316, the sensors 400A and 400B can be configured to remain stationary during the second inspection phase. In addition, the sensor 400A can inspect the area 804 while the sensor 400B inspects the area 808 of the web 604. The sensors 400A and 400B can be configured to respectively inspect the areas 804 and 808 during the second inspection phase. It should be noted that in some embodiments, the areas 804 and 808 may overlap with each other such that the sensors 400A and 400B may be configured to inspect areas that overlap with each other.

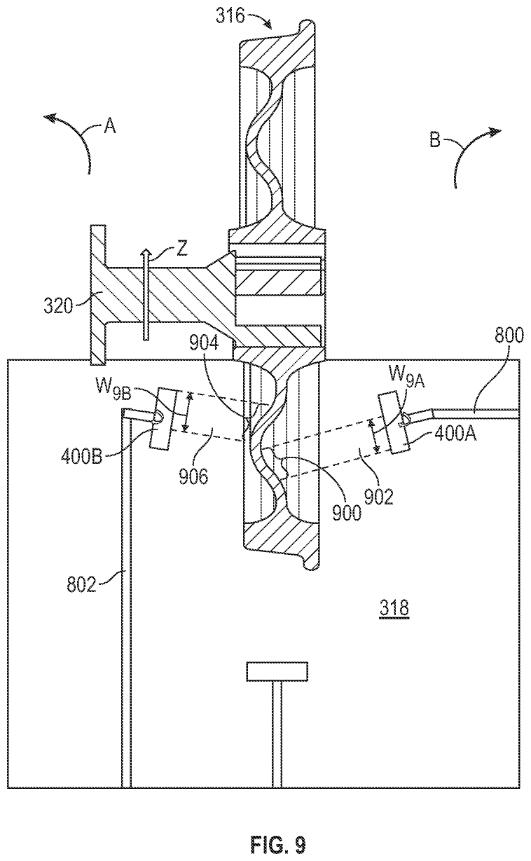

Upon completion of the second inspection phase, the controller 322 can control the robot arms 304 and 306 to move the axle 320 in an upward direction Z during a third inspection phase into the position shown with respect to FIG. 9. When the axle 320 moves upwardly in the upward direction Z, the axle 320 can lift the article 316 within the bath 318 such that only the rim 600 and the web 604 are immersed in the bath 318 in the third inspection phase. Thus, a portion of the rim 600, such as half the rim, is immersed in the bath 318 along with a portion of the web 604. It should be noted that the robotic arms 304 and 306 can be configured to function to lift the axle 320 such that a portion of the hub 602 of the article 316 remains within the bath 318 during the third inspection phase. During this inspection phase, the controller 322 can be configured to control the sensor 400A such that the sensor 400A can be upwardly moved about the arm 800 relative to the bath 318 in the direction B in order to allow the sensor 400A to inspect an area 900 of the web 604. Here, the pulsing elements 500 of the sensor 400A can be controlled by an electronic device to emit a beam 902 having a width W_{9A} to inspect the area 900. In an implementation, the width W_{9A} is determined in a manner similar to that discussed above with reference to the width W_{8A} of the beam 806. As the sensor 400A inspects the area 900 of the web 604, the controller 322 can be configured to control the axle 320 to rotate the article 316 in the bath 318 such that the sensor 400A can inspect the entire web 604 at the area 900.

In addition, the controller 322 can be configured to control the sensor 400B to be upwardly moved about the arm 802 relative to the bath 318 along the direction A such that the sensor 400B inspects an area 904 of the web 604. Specifically, the pulsing elements 500 of the sensor 400B are controlled by an electronic device to emit a beam 906 having a width W_{9B} to inspect the area 904. In an implementation, the width W_{9B} is determined in a manner similar to that described above with reference to the width W_{8B} of the beam 810. While the sensor 400B inspects the area 904 of the web 604, the controller 322 can be configured to control the axle 320 to rotate the article 316 in the bath 318 such that the sensor 400B can inspect the entire web 604 at the area 904. Since the axle 320 rotates the article 316 as the sensors 400A and 400B inspect the article 316, the sensors 400A and 400B remain stationary during the third inspection phase. Contemporaneously, as the sensor 400A inspects the area 900, the controller 322 can be configured to control the sensor 400B to inspect the area 904 of the web 604. The sensors 400A and 400B can be used to respectively inspect the areas 900 and 904 during the third inspection phase.

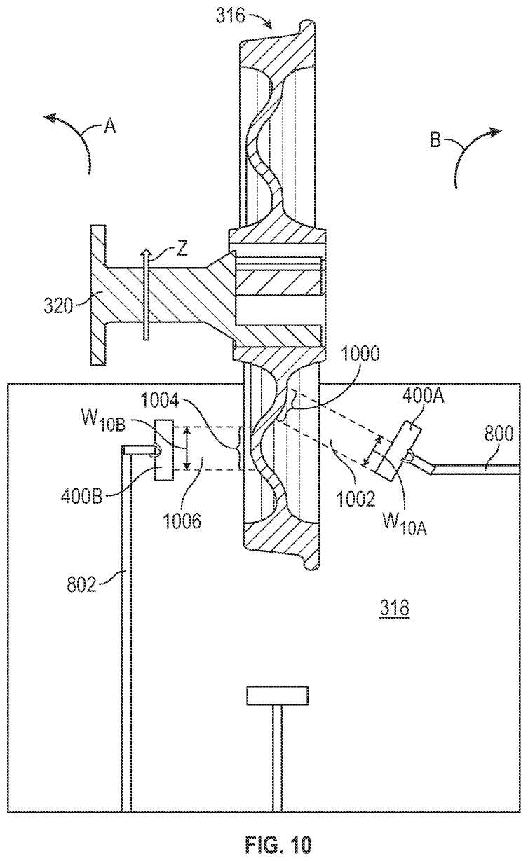

Once the third inspection phase is completed, the controller 322 can control the robot arms 304 and 306 to move the axle 320 in further in the upward direction Z during a fourth inspection phase into the position shown with respect to FIG. 10. After the axle 320 further lifts the article 316 as shown with regards to FIG. 10, in addition to the hub 602, a portion of the web 604 is also no longer in the bath 318. During the fourth inspection phase, the controller 322 can be configured to control the sensor 400A to upwardly move relative to the bath 318 along the direction B such that the sensor 400A has the configuration shown with reference to FIG. 10. In this position, the sensor 400A can be configured to scan an area 1000 of the web 604. Similar to inspection phases one through three, the pulsing elements 500 of the sensor 400A can be controlled by the controller 322 to emit a beam 1002 having a W_{10A} to inspect the area 1000. In an implementation, the width W_{10A} is determined in a manner similar to that discussed above with reference to the width W_{8A} of the beam 806. As the sensor 400A is configured to inspect the area 1000 of the web 604, the controller 322 can be configured to control the axle 320 to rotate the article 316 in the bath 318 enabling the sensor 400A to inspect the entire web 604 at the area 1000.

Furthermore, in an implementation, the controller 322 can be configured to control the sensor 400B to upwardly move about the arm 802 relative to the bath 318 in the direction A in order to allow the sensor 400B to inspect an area 1004. In an implementation, the pulsing elements 500 of the sensor 400B can be controlled by the controller 322 to emit a beam 1006 having a width W_{10B} to inspect the area 1004. In an implementation, the width W_{10B} is determined in a manner similar to that used to determine a width W_{8B} of the beam 810. While the sensor 400B is configured to inspect the area 1004 of the web 604, the axle 320 can be configured to rotate the article 316 in the bath 318 enabling the sensor 400B to inspect the entire web 604 at the area 1004. Since the axle 320 rotates the article 316 as the sensors 400A and 400B are configured to inspect the article 316, the sensors 400A and 400B can remain stationary during the fourth inspection phase. In addition, the sensor 400A can be controlled by the controller 322 to inspect the area 1000 while the sensor 400B inspects the area 1004 of the web 604 during the fourth inspection phase.

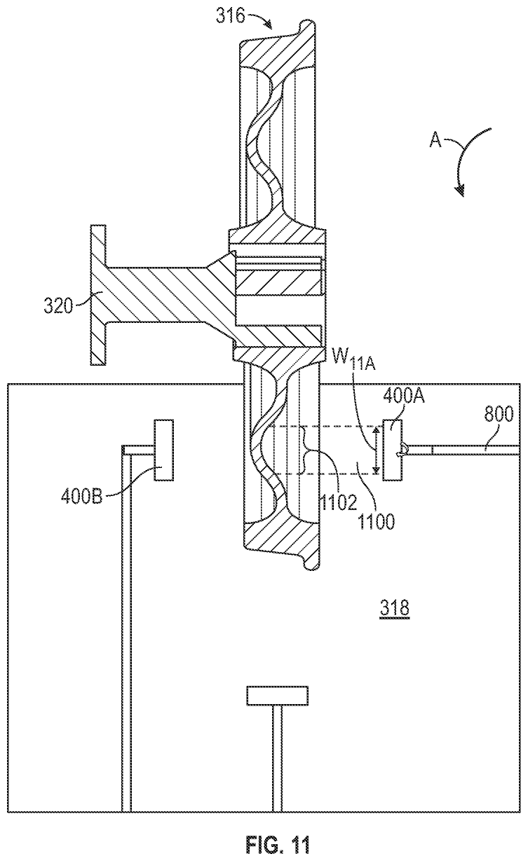

After the sensors 400A and 400B are used to respectively inspect the areas 1000 and 1004 of the hub 602 during the fourth inspection phase, the controller 322 can be configured to control the sensor 400A to downwardly move relative to the bath 318 in the direction A such that the sensor 400A has the orientation shown with regards to FIG. 11. In an implementation, the sensor 400A has the orientation shown in FIG. 11 during a fifth inspection phase. During the fifth inspection phase, the pulsing elements 500 of the sensor 400A can be controlled by the controller 322 to emit a beam 1100 having a width W_{11A} in order to inspect an area 1102 of the hub 602. In an implementation, the width W_{11A} is determined in a manner similar to that discussed above with reference to the width W_{8A} of the beam 806. During this inspection phase, the sensor 400B can be in an off mode such that the sensor 400B is not performing an inspection of the article 316. Similar to the first through fourth inspection phases, the controller 322 can be configured to control the axle 320 to rotate the article 316 in order to allow the sensor 400A to inspect the area 1102 along an entirety of the hub 602. The sensor 400A can be configured to inspect the area 1102 during the fifth inspection phase.

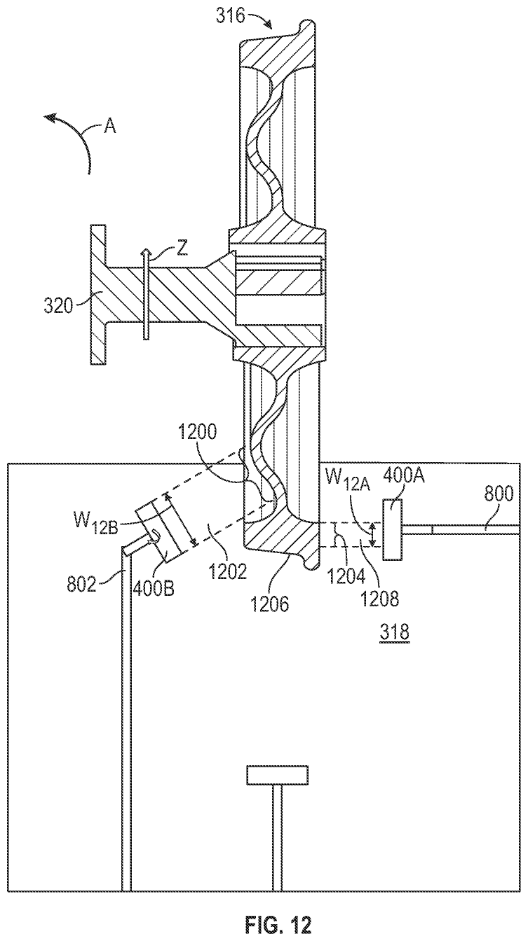

Upon completion of the fifth inspection phase, the controller 322 can be configured to control the robotic arms 304 and 306 to move the axle 320 in the upward direction Z, thereby raising the article 316 out of the bath 318, in a sixth inspection phase. In the sixth inspection phase, the controller 322 can be configured to control the sensor 400B to upwardly move about the arm 802 relative to the bath 318 in the direction A such that the sensor 400B is configured as shown with reference to FIG. 12. In this implementation, the sensor 400B is configured to inspect an area 1200 of the web 604. Specifically, the pulsing elements 500 of the sensor 400B can be controlled by the controller 322 to emit a beam 1202 having a width W_{12B} to inspect the area 1200. In an implementation, the width W_{10B} is determined in a manner similar to that used to determine a width W_{8B} of the beam 810. As the sensor 400B inspects the area 1200 of the web 604, the controller 322 can be configured to control the axle 320 to rotate the article 316 in the bath 318 such that the sensor 400B can be configured to inspect the entire web 604 at the area 1200. Since the axle 320 rotates the article 316 as the sensor 400B inspects the article 316, the sensor 400B can remain stationary during the sixth inspection phase.

In addition to the sensor 400B inspecting the area 1200 of the web 604, the sensor 400A can be configured to inspect an area 1204 of a rib 1206 of the article 316. Here, the pulsing elements 500 of the sensor 400A can be controlled by the controller 322 to emit a beam 1208 having a width W_{12A} to inspect the area 1204. Here, the width W_{12A} can be ascertained using a procedure similar to that used to determine the width W_{8A} of the beam 806. As the sensor 400A is configured to inspect the area 1204 of the rib 1206, the axle 320 can rotate the article 316 in the bath 318 such that the sensor 400A can be configured to inspect the entire rib 1206 at the area 1204. Furthermore, the sensor 400A can be configured to inspect the area 1204 while the sensor 400B inspects the area 1200 of the web 604. The sensors 400A and 400B can respectively inspect the areas 1200 and 1204 during the sixth inspection phase. After the sensors 400A and 400B be configured to inspect the areas 1200 and 1204 of the article 316, the robotic arms 304 and 306 are controlled to remove the article 316 from the bath 318 if an additional inspection is not necessary.

While implementations of the present disclosure have been discussed as inspecting the article 316 in six inspection phases, it should be noted that implementations envision using less than six inspection phases or more than six inspection phases. In some implementations, the size of the article 316 can be configured to determine the number of inspection phases. For example, for an article having a large diameter, a greater number of inspections by the sensors 400A and 400B would be warranted in comparison to an article having a smaller diameter. Moreover, as noted above, in the past, a path used to examine an article may have a width of 6 mm, thereby necessitating multiple inspection phases. Here, the width W_{8A}-W_{12A} of the beams 806, 902, 1002, 1100, and 1204 may be in a range of about 200 mm to about 600 mm. Likewise, the width W_{8B}-W_{10B} and W_{12B} of the beams 810, 906, 1006, and 1202 may be in a range of about 200 mm to about 600 mm. Moreover, while the sensors 400A and 400B have been described as being movable, the sensors 400A and 400B may also be pivotable as described above.

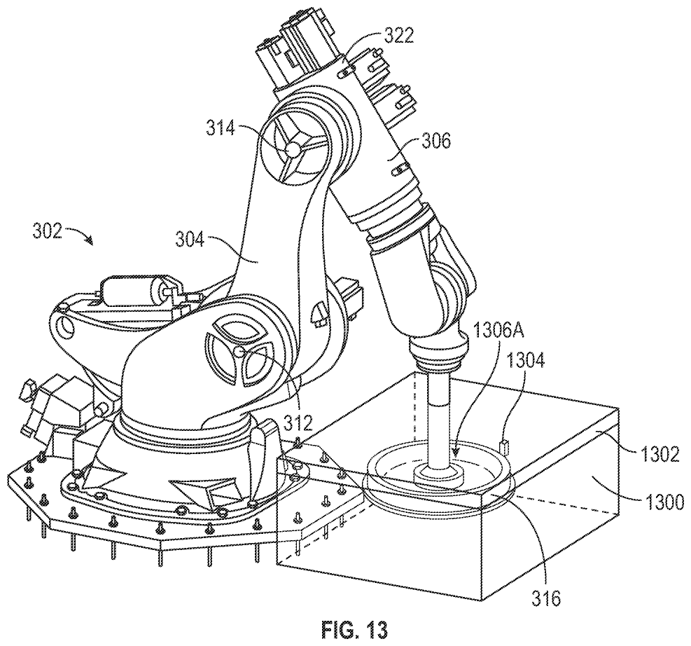

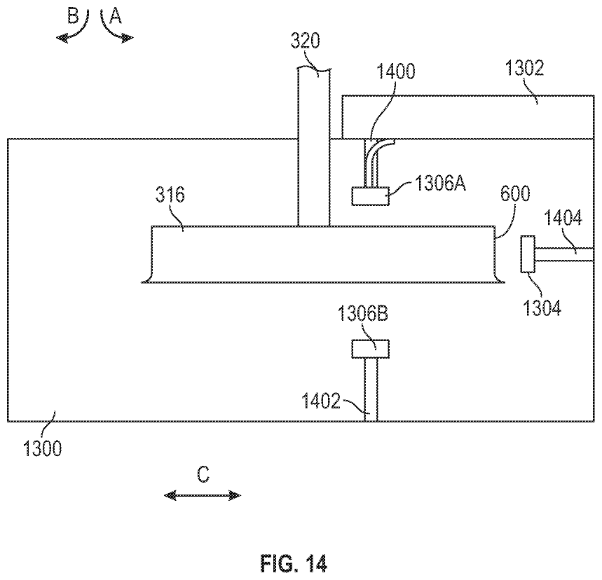

FIGS. 3-12 describe implementations where the robot 302 can be configured to place the article 316 into the bath 318 in a vertical configuration. In further implementations, the controller 322 can be configured to control the robot 302 to place the article 316 into a bath 1300 in a horizontal position, as shown with reference to FIG. 13. In this implementation, the bath 1300 includes a couplant similar to the bath 318 discussed above along with a lid 1302. The bath 1300 includes a sensor 1304 along with a sensor 1306A coupled with the lid 1302 and a sensor 1306B (FIG. 14). As may be seen with regards to FIG. 14, the sensor 1306A can couple with the lid 1302 via an arm 1400. During an inspection of the article 316, the controller 322 can be configured to control the sensor 1306A to move about the arm 1400 in either the direction A or the direction B relative to the bath 1300. Moreover, in an implementation, the sensor 1306A can be functionally similar performed to the sensor 400A. Thus, the sensor 1306A can include pulsing elements controlled by the controller 322 to emit a beam to inspect different areas of the article 316, similar to the sensor 400A. In an implementation, the controller 322 can be configured to control the axle 320 to move the article in a direction C during inspection of article 316 and, as discussed with reference to FIGS. 7A and 8-12 and the sensor 400A, the sensor 1306A can inspect the article 316.

The sensor 1306B can be coupled with the bath 1300 via an arm 1402. During an inspection of the article 316, the controller 322 can be configured to control the sensor 1306B to move about the arm 1402 in either the direction A or the direction B relative to the bath 1300. In an implementation, the sensor 1306B can have functionality that is similar to the sensor 400B. Thus, the sensor 1306B can include pulsing elements that can be controlled by the controller 322 to emit a beam to inspect different areas of the article 316, similar to the sensor 400B. For example, as discussed above with reference to FIGS. 7A, 8-10, and 12, the sensor 1306B can inspect the article 316 as the axle 320 moves the article 316 in the direction C.

The sensor 1304 can be coupled with the bath 1300 via an arm 1404 and inspect the rim 600 of the article 316 as discussed above with reference to the sensor 402. In particular, the controller 322 can be configured to control the axle 320 to move the article 316 in the direction C such that the sensor 1304 can be configured to inspect the rim 600, as discussed above with reference to FIG. 7A and the sensor 402.

It should be noted that while the sensors 400A, 400B, and 402 are described as inspecting different areas 804, 808, 900, 904, 1000, 1004, 1102, 1200, and 1204, the sensors 400A, 400B, and 402 can be configured to inspect overlapping areas where portions of the areas 804, 808, 900, 904, 1000, 1004, 1102, 1200, and 1204 overlap while other portions of the area 804, 808, 900, 904, 1000, 1004, 1102, 1200, and 1204 are separate.

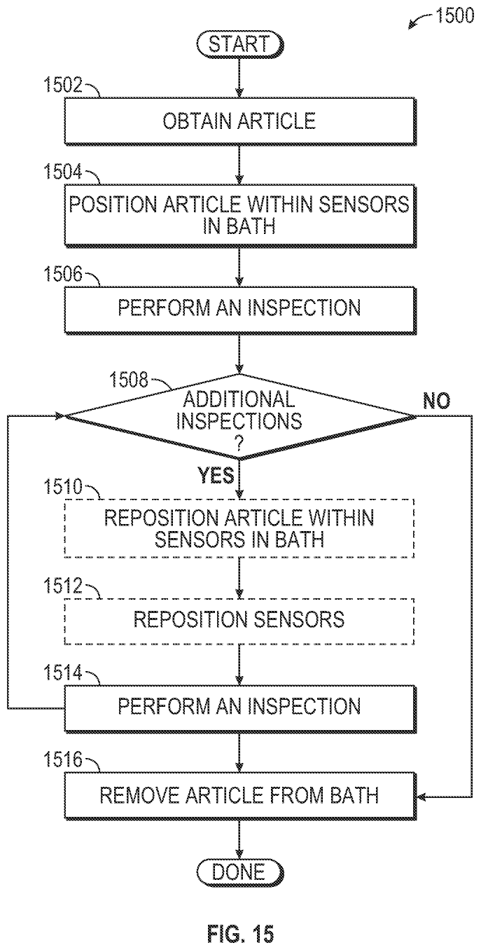

Now making reference to FIG. 15, a method 1500 of inspecting an article is disclosed, in accordance with an implementation of the present disclosure. In this implementation, a controller, such as the controller 322 discussed above, can be used to perform the operations 1502-1516 detailed below. In an operation 1502, a robot is configured to obtain an article and positions the article within sensors in a bath in an operation 1504. In some implementations, the article may be obtained in either a vertical or horizontal position. In some implementations, the robot can be configured to obtain the article from an assembly line that manufactures the article, such as an assembly line that manufactures railway wheels. As part of the manufacturing process, the railway wheels are inspected to ensure compliance with necessary standards, such as EN13262, ISO5948, and AAR M107/208. After the robot obtains the article and places the article within the sensors in a bath, an inspection is performed in an operation 1506. As detailed above, various areas of the article are inspected to ascertain if the article has any flaws, such as cracks or any other material defects. In addition, during the operation 1506, the sensors inspect the article for during the inspection.

As an example, making reference to FIG. 7A, in the operation 1502, the controller 322 is configured to control the robot 302 to obtain the article 316 and then place the article 316 between the sensors 400A and 400B above the sensor 402 as shown with reference to FIG. 7A. Then, in the operation 1506, the controller 322 is used to control the sensors 400A and 400B to inspect the hub 602 of the article 316 while controlling the sensor 402 to inspect the rim 600 of the article 316. As discussed above, the axle 320 rotates the article 316 such that the sensors 400A and 400B inspect the entire hub 602 and the sensor 402 inspects the entire rim 600. After the sensors 400A and 400B along with the sensor 402 inspect the article 316, an operation 1508 is performed, as shown with reference to FIG. 15.

In the operation 1508, a determination is made if additional inspections are necessary. In an implementation, this determination is made based on whether or not there are additional areas of the article that have not been inspected. If a determination is made that an article has additional areas that require inspection, then an operation 1510 can optionally be performed, where the article is repositioned within the sensors in the bath. In the operation 1510, the article can optionally be repositioned such that the sensors may inspect the areas of the article that were not inspected in the operation 1506. Furthermore, in some implementations, when the article is repositioned within the sensors and the bath, the sensors can optionally be repositioned in an operation 1512. Once either the article is repositioned within the sensors in the operation 1510 or the sensors are repositioned in the operation 1512, an operation 1514 can be performed, where an inspection of the article is performed similar to the inspection performed in the operation 1506. It should be noted that while both of the operations 1510 and 1512 are discussed as being performed, in some implementations, the operations 1510 and 1512 can be performed independently from each other or in any sequence. For example, the operation 1512 may be performed prior to performing the operation 1510, the operation 1512 may be performed multiple times while the operation 1510 is performed once, or the operation 1510 may be performed multiple times while the operation 1512 is performed once, or any other combination.

Returning to the example, in the operation 1508, after the sensors 400A, 400B, and 402 perform an inspection on the article 316, the controller 322 determines that the article 316 includes the areas 804 and 808 that also need to be inspected in the operation 1508. Therefore, in the example, the operation 1512 can be performed where the sensors 400A and 400B are repositioned as previously discussed with regards to FIG. 8. As noted above, the operation 1510 is optional. In the example, the controller 322 is allowed to determine that the axle 320 does not need to reposition the article 316 within the sensors 400A and 400B. Therefore, the axle 320 does not reposition the article 316. However, it should be noted that in accordance with implementations, the controller 322 may be used to determine that the article 316 should be repositioned and accordingly instruct the axle 320 to reposition the article 316. Instead, in the example, the controller 322 repositions the sensors 400A and 400B in the operation 1512 such that the sensors 400A and 400B have the orientation shown with reference to FIG. 8. Once the sensors 400A and 400B are repositioned in the operation 1512, in this example, the article 316 is inspected in the operation 1514.

After inspection of the article in the operation 1514, the method 1500 repeats the operation 1508 where a determination is made if another inspection of the article should be completed. If the controller determines that other areas of the article should be inspected, the operations 1510-1514 are repeated. Returning to the example, after completion of the operation 1514, the controller 322 repeats the operation 1508, where the controller 322 determines that any of the areas 804, 808, 900, 904, 1000, 1004, 1102, 1200 and 1204 should be inspected. Thus, the operation 1510 is performed, where the controller 322 controls the axle 320 to move in the direction Z in order to reposition the article 316 within the sensors 400A and 400B, as shown with regards to FIG. 9. Moreover, the controller 322 is configured to perform the operation 1512, where the sensors 400A and 400B are repositioned relative to the article 316, also as shown with reference to FIG. 9. After repositioning of both the article 316 and each of the sensors 400A and 400B, another inspection of the article 316 is performed as described above with reference to FIG. 9 in the operation 1514. Upon completion of the inspection in the operation 1514, the operation 1508 is repeated to enable controller 322 to determine if an additional inspection of the article 316 should be performed.

As discussed above, after inspection of the article in the operation 1514, the method 1500 repeats the operation 1508 where a determination is made if another inspection of the article should be completed. If the controller determines that other areas of the article should be inspected, the operations 1510-1514 are repeated. Returning to the example, in the operation 1508, the controller repeats the operation 1508, where a determination is made that the areas 1000, 1004, 1102, 1200, 1202 and the rib 1204 should be inspected. Therefore, the operations 1508-1514 are repeated until the areas 1000, 1004, 1102, 1200, 1202 and the rib 1204 are inspected.

Once a determination is made that no other areas of the article should be inspected, the method 1500 can perform an operation 1516, where the article is removed from the bath. Returning to the example, after all areas of the article 316, such as, for example, the areas 804, 808, 900, 904, 1000, 1004, 1102, and 1200 and the rib 1204, along with are inspected, the controller 322 determines that no other areas of the article 316 should be inspected. Thus, the controller 322 can be configured to control the robotic arms 302 and 306 to remove the article 316 from the bath 318.

In a first example, a method of an inspecting an article using a system having a robotic arm, a bath having a couplant, and a plurality of sensors disposed within the bath is provided. In the first example, the method comprises obtaining the article with the robotic arm; positioning the article within the plurality of sensors in the bath, wherein the plurality of sensors include: a first sensor coupled with the bath, the first sensor positioned within the bath such that the first sensor is configured to inspect a first area of an article disposed within the bath; a second sensor coupled with the bath opposite the first sensor, the second sensor positioned within the bath such that the second sensor is configured to inspect a second area of the article disposed within the bath separate from the first area of the article; and a third sensor coupled with the bath, the third sensor positioned within the bath such that the third sensor is configured to inspect a third area of the article separate from the first area of the article and the second area of the article disposed within the bath, wherein at least one of the first sensor, the second sensor, and the third sensor is coupled with the bath such that during an inspection of the article within the bath; performing an inspection of an area of the article with at least one of the sensors; determining if an additional inspection is necessary; performing an additional inspection of an additional area of the article when the additional inspection is necessary, wherein performing the additional inspection includes one of repositioning the article within the plurality of sensors before performing the inspection with the robotic arm; and repositioning the at least one of the sensors into another position before performing the inspection; and removing the article from within the plurality of sensors and the bath with the robotic arm when the additional inspection is not necessary.

In the first example, at least one of the first sensor, the second sensor, and the third sensor is pivotally coupled with the bath such that during an inspection of the article within the bath, the at least one of the first sensor, the second sensor, and the third sensor is configured to pivot relative to the bath and during the inspection of the area of the article with at least one of the sensors, the at least one of the sensors is pivoted into position to inspect the article.

In the first example, a second position of the first sensor, the second sensor, and the third sensor is configured to move relative to the bath and the operation of performing an additional inspection of an additional area of the article when the additional inspection is necessary. In the first example, performing the additional inspection includes repositioning the article within the plurality of sensors before performing the inspection; and repositioning the at least one of the sensors by moving the at least one sensor into another position before performing the inspection.

In the first example, each of the first sensor, the second sensor, and the third sensor are phased array sensors and include a plurality of pulsing elements that emit beams to perform refracted shear-wave ultrasonic inspections.

In the first example, a width of the emitted beams is in a range between 30 mm and 70 mm.

In the first example, each of the first sensor, the second sensor, and the third sensor include a subset of the plurality of the pulsing elements emits beams while performing the refracted shear-wave ultrasonic inspections.

In the first example, each of the first sensor, the second sensor, and the third sensor are configured to simultaneously inspect the article.

In a second example, a method of inspecting an article using a system having a robotic arm, a bath having a couplant, and a plurality of sensors disposed within the bath is provided. Initially, the robotic arm is configured to obtain the article and then position the article within the sensors in the bath. In an embodiment, the sensors can include a first sensor coupled with the bath, a second sensor coupled with the bath opposite the first sensor, and a third sensor coupled with the bath. In an embodiment, the first sensor can be positioned within the bath such that the first sensor is configured to inspect a first area of the article. Furthermore, the second sensor can be positioned within the bath such that the second sensor is configured to inspect a second area of the article; Additionally, the third sensor can be positioned within the bath such that the third sensor is configured to inspect a third area of the article separate from the first area of the article and the second area of the article.

In the second example, in an embodiment, one of the sensors can be pivotally coupled with the bath such that during an inspection of the article within the bath, one of the sensors can be configured to move relative to the bath. In an embodiment, once the article is positioned in the bath, an inspection of an area of the article with at least one of the sensors is performed where one of the sensors is configured to be moved into position to inspect the article.

In the second example, a determination can be made if an additional inspection of an additional area should be performed. If an additional inspection of an additional area of the article should be performed, in order to perform the additional inspection, either the article can be repositioned within the plurality of sensors before performing the inspection with the robotic arm or the at least one of the sensors can be repositioned by moving into another inspecting position or areas before performing the inspection. Once a determination is made that no further inspections should be made, the robotic arm can be controlled to remove the article from within the plurality of sensors and the bath.

In the second example, performing the additional inspection includes repositioning the article within the plurality of sensors before performing the inspection and repositioning the at least one of the sensors by moving the at least one sensor into another position for inspection.

In the second example, each of the first sensor, the second sensor, and the third sensor are phased array sensors and include a plurality of pulsing elements that emit beams to perform refracted shear-wave ultrasonic inspections.

In the second example, a width of the emitted beams is in a range between 30 mm and 70 mm.

In the second example, each of the first sensor, the second sensor, and the third sensor include a subset of the plurality of the pulsing elements emits beams while performing the refracted shear-wave ultrasonic inspections.

In the second example, each of the first sensor, the second sensor, and the third sensor are configured to simultaneously inspect the article.

In a third example, a method of an inspecting an article using a system having a robotic arm, a bath having a couplant, and a plurality of sensors disposed within the bath is provided. Initially, the robotic arm is configured to obtain the article and then position the article within the sensors in the bath. In an embodiment, the sensors can include: a first sensor coupled with the bath, a second sensor coupled with the bath opposite the first sensor, and a third sensor coupled with the bath. In an embodiment, the first sensor can be coupled with the bath and positioned such that the first sensor is configured to inspect a first area of an article disposed within the bath. In an embodiment, the second sensor can be positioned within the bath such that the second sensor can be configured to inspect a second area of the article disposed within the bath. Furthermore, the third sensor can be configured to inspect a third area of the article separate from the first area of the article and the second area of the article disposed within the bath. In an embodiment, one of the sensors can be coupled with the bath such that during an inspection of the article within the bath, is the sensor can be configured to move relative to the bath.

In the third example, an inspection of an area of the article can be performed with one of the sensors, where one of the sensors is moved into position to inspect the article. In the third example, a determination is made if an additional inspection is necessary. If a determination is made that an additional inspection is necessary, the article is repositioned within the plurality of sensors and an additional inspection of an additional area is performed. After the additional inspection is performed, the robotic arm removes the article from within the plurality of sensors and the bath.

In the third example, performing the additional inspection includes repositioning the at least one of the sensors by pivoting the at least one sensor into another position before performing the inspection.

In the third example, each of the first sensor, the second sensor, and the third sensor are phased array sensors and include a plurality of pulsing elements that emit beams to perform refracted shear-wave ultrasonic inspections and a width of the emitted beams is in a range between 30 mm and 70 mm.

In the third example, each of the first sensor, the second sensor, and the third sensor include a subset of the plurality of the pulsing elements emits beams while performing the refracted shear-wave ultrasonic inspections.

In the third example, each of the first sensor, the second sensor, and the third sensor are configured to simultaneously inspect the article.

The above detailed description includes references to the accompanying drawings, which form a part of the detailed description. The drawings show, by way of illustration, specific examples in which the invention can be practiced. These examples are also referred to herein as examples. Such examples can include elements in addition to those shown or described. However, the present inventor also contemplates examples in which only those elements shown or described are provided. Moreover, the present inventor also contemplates examples using any combination or permutation of those elements shown or described (or one or more aspects thereof), either with respect to a particular example (or one or more aspects thereof), or with respect to other examples (or one or more aspects thereof) shown or described herein.

In this document, the terms a or an are used, as is common in patent documents, to include one or more than one, independent of any other instances or usages of at least one or one or more. In this document, the term or is used to refer to a nonexclusive or, such that A or B includes A but not B, B but not A, and A and B, unless otherwise indicated. In this document, the terms including and in which are used as the plain-English equivalents of the respective terms comprising and wherein. Also, in the following claims, the terms including and comprising are open-ended, that is, a system, device, article, composition, formulation, or process that includes elements in addition to those listed after such a term in a claim are still deemed to fall within the scope of that claim. Moreover, in the following claims, the terms first, second, and third, etc. are used merely as labels, and are not intended to impose numerical requirements on their objects.

The above description is intended to be illustrative, and not restrictive. For example, the above-described examples (or one or more aspects thereof) may be used in combination with each other. Other examples can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed example. Thus, the following claims are hereby incorporated into the Detailed Description as examples or examples, with each claim standing on its own as a separate example, and it is contemplated that such examples can be combined with each other in various combinations or permutations. The scope of the invention should be determined with reference to the appended claims, along with the full scope of equivalents to which such claims are entitled.

What is claimed:

1. A bath for inspecting an article, the bath comprising:
a plurality of sensors disposed within the bath, the plurality of sensors including:
a first sensor positioned within the bath, wherein the first sensor is configured to inspect a first area of an article disposed within the bath through a couplant;
a second sensor positioned within the bath, wherein the second sensor is configured to inspect a second area of the article disposed within the bath through the couplant; and
a third sensor positioned within the bath such that the third sensor is configured to inspect a third area of the article at least partially separate from the first area of the article and at least partially separate from the second area of the article through the couplant,

2. The bath as recited in claim 1, wherein at least a second one of the first sensor, the second sensor, and the third sensor is configured to move relative to the bath for inspection of the article.

3. The bath as recited in claim 1, wherein each of the first sensor, the second sensor, and the third sensor is a phased array probe and includes a plurality of pulsing elements configured to emit beams to perform refracted shear-wave ultrasonic inspections.

4. The bath as recited in claim 3, wherein a width of the emitted beams is in a range between 30 mm and 70 mm.

5. The bath as recited in claim 3, wherein each of the first sensor, the second sensor, and the third sensor includes a subset of the plurality of the pulsing elements configurable to emit beams while performing the refracted shear-wave ultrasonic inspections.

6. The bath as recited in claim 1, wherein each of the first sensor, the second sensor, and the third sensor is configured for contemporaneous inspection of the article.

7. An inspection system comprising:
a bath defining a vessel for a couplant therein;
at least one robotic arm;
an axle coupled to the at least one robotic arm, where the at least one robotic arm and the axle are configured to place an article within the bath; and
a plurality of sensors disposed within the bath, the plurality of sensors including:
a first sensor positioned within the bath such that the first sensor is configured to inspect a first area of the article disposed within the bath through a couplant;
a second sensor positioned within the bath such that the second sensor is configured to inspect a second area of the article disposed within the bath having a portion through the couplant; and
a third sensor positioned within the bath such that the third sensor is configured to inspect a third area of the article at least partially separate from the first area of the article and at least partially separate from the second area of the article disposed within the bath through the couplant.

8. The inspection system as recited in claim 7, wherein at least one of of the first sensor, the second sensor, and the third sensor is configured to move relative to the bath if an additional inspection is necessary

9. The inspection system as recited in claim 7, wherein each of the first sensor, the second sensor, and the third sensor is phased array probe and includes a plurality of pulsing elements configured to emit beams to perform refracted shear-wave ultrasonic inspections.

10. The bath as recited in claim 9, wherein a width of the emitted beams is in a range between 30 mm and 70 mm.

11. The inspection system as recited in claim 9, wherein each of the first sensor, the second sensor, and the third sensor includes a subset of the plurality of the pulsing elements that are configured to emit beams while performing the refracted shear-wave ultrasonic inspections.

12. The inspection system as recited in claim 7, wherein each of the first sensor, the second sensor, and the third sensor is configured for contemporaneous inspection of the article.

13. The inspection system as recited in claim 7, wherein at least one of the first sensor, the second sensor, and the third sensor is configured to move relative to the bath when the at least one robotic arm and axle move the article within the bath for inspection of the article.

14. A method of an inspecting an article using a system having at least one robotic arm, a bath having a couplant, and a plurality of sensors disposed within the bath, the method comprising:
obtaining the article with the at least one robotic arm;
positioning the article within the plurality of sensors in the bath;
performing an inspection of an area of the article, wherein performing the inspection includes one of:
repositioning the article within the plurality of sensors before performing the inspection with the at least one robotic arm; and
repositioning the at least one of the sensors into another position before performing the inspection; and
determining an additional inspection if necessary.

15. The method as recited in claim 14, further comprising:
enabling to configure a first sensor coupled with the bath to position to inspect a first area of an article disposed within the bath;
enabling to configure a second sensor coupled with the bath to position to inspect a second area of the article disposed within the bath;
enabling to configure a third sensor coupled with the bath to inspect a third area of the article separate from the first area of the article and the second area of the article disposed within the bath;
performing an inspection of an area of the article with at least one of the sensors; and
determining if an additional inspection is necessary.

16. The method as recited in claim 15, wherein at least one of the first sensor, the second sensor, and the third sensor is coupled with the bath during an inspection of the article and configured to move relative to the bath to inspect the article.

17. The method as recited in claim 16, wherein performing the additional inspection includes:
repositioning the article within the plurality of sensors before performing the inspection; and
repositioning the at least one of the sensors by moving the at least one sensor into another position before performing the inspection.

18. The method as recited in claim 15, wherein each of the first sensor, the second sensor, and the third sensor is phased array probe with a plurality of pulsing elements to perform refracted shear-wave ultrasonic inspections.

19. The method as recited in claim 15, wherein each of the first sensor, the second sensor, and the third sensor is configured to simultaneously inspect the article.

20. The method as recited in claim 14, further comprising:
determining that inspection of the article is complete; and
configuring the at least one robot arm to remove the article from the bath.
